(19) United States
(12) Patent Application Publication
(10) Pub. No.: US 2011/0057762 A1
(43) Pub. Date: Mar. 10, 2011

(54) SHORT-CIRCUITING APPARATUS WITH PYROTECHNIC INITIATION

(75) Inventors: Jens Burger, Dallgow-Doberitz (DE); Jörg Dorn, Buttenheim (DE); Thomas Kübel, Erlangen (DE); Roman Renz, Berlin (DE); Andreas Stelzer, Berlin (DE); Andreas Zenkner, Obermichelbach (DE)

(73) Assignee: SIEMENS AKTIENGESELLSCHAFT, MÜNCHEN (DE)

(21) Appl. No.: 12/864,153

(22) PCT Filed: Jan. 6, 2009
(86) PCT No.: PCT/EP2009/050062

§ 371 Date: Oct. 5, 2010

(30) Foreign Application Priority Data
Jan. 22, 2008 (DE) 10 2008 005 887.4

(51) Int. Cl. H01H 39/00

(52) U.S. Cl. 337/401

(57) ABSTRACT

A short-circuit device for the electrical bypass of an electric module has a contact arrangement, which is disposed in a switching chamber. The contact arrangement has an open circuit-breaker setting, in which a current flow via the contact arrangement is interrupted, and a contact setting, in which a current flow via the contact arrangement is made possible. A pyrotechnic drive for transferring the contact arrangement from its circuit breaker setting into its contact setting, enables cost-effective, rapid bypass or short-circuiting, and the provision of a large current carrying capacity simultaneously. The switching chamber is a vacuum switching chamber in which a vacuum prevails.

The invention relates to a short-circuiting apparatus for electrically bridging an electrical module having a contact assembly which is arranged in a switching chamber and has an interrupter position, in which a current flow via the contact assembly is interrupted, and a contact position in which a current can flow via the contact assembly, and having a pyrotechnic drive for moving the contact assembly from its interrupter position to its contact position.

The invention furthermore relates to an apparatus for converting an electrical current in the field of power transmission and distribution with power semiconductor modules which are connected to one another via electrical connecting means forming a series circuit, wherein each power semiconductor module has an associated short-circuiting device for bridging the respective power semiconductor module.

A short-circuiting apparatus such as this is already known from DE 102 54 497 B3. The short-circuiting apparatus described there is used for short-circuiting phases of an electrical power supply line in the low-voltage or medium-voltage range. The short-circuiting device is intended to prevent a fault arc from occurring in the event of a malfunction. For this purpose, the phases of the electrical power supply line are short-circuited, such that the energy is extracted from the fault arc, and in the end the fault arc is quenched. A reaction chamber which is filled with a gas with the capability to carry out a photochemical reaction is used to initiate the short-circuiting apparatus. The reaction energy which is released explosively when this photochemical reaction takes place is used to close contacts of the short-circuiting apparatus. The photochemical reaction is initiated by injecting light from the fault arc into the reaction chamber by means of optical waveguides.

Further short-circuiting apparatuses with a pyrotechnic drive are described, for example, in EP 1 282 145 A1, WO 9741582 or DE 199 55 682 A1.

DE 103 45 502 A1 discloses a high-speed drive for a vacuum interrupter tube. The drive has an electrical switch, whose closing short-circuits an energy store. This results in a liquid being heated, whose vaporization gases, which occur explosively, close the vacuum interrupter tube. In contrast to initiation of a pyrotechnic drive, the vaporization of liquids is repeatable.

The apparatus mentioned initially was disclosed in WO 2007/095873 A1. The apparatus disclosed there is intended to short-circuit power semiconductor modules in which the power semiconductor modules are, for example, connected in series and form a phase module of a converter. The converter is used to convert an alternating electric current to a direct current, or vice versa. A short-circuiting device, by means of which a faulty power semiconductor module can be bridged, is provided in order to allow the operation of the converter to continue with the aid of the sound power semiconductor modules in the event of a malfunction of this single power semiconductor module. The short-circuiting device comprises a pyrotechnically mechanical element, which has an explosive charge and an initiating means which can be moved by the explosive charge.

In practice, it has been found that, in the field of high-voltage and medium-voltage technology, such power semiconductor modules must be short-circuited in as short a time as possible, in order to make it possible to effectively restrict extensive damage to the converter. Because of the high speed requirements, only small masses can be moved by the pyrotechnic drive, however, according to the prior art. This results in the pyrotechnically driven contact assembly having a limited current carrying capability. For this reason, a second parallel-switched contact was closed according to the prior art, wherein the drive for the parallel contact was a spring storage drive. This spring storage drive is likewise released when the pyrotechnic drive is initiated. The closing time for the parallel-switched contact, that is to say the second stage, is, however, slower than that of the pyrotechnically driven switch, and is in the region of several milliseconds. However, the closing of the second stage results in the required current carrying capability. However, the two-stage switching results in a high level of mechanical complexity. Furthermore, because of the air gaps which need to be maintained and the parallel design of the mechanical and pyrotechnic switch, a large amount of space is required. In addition, the two-stage switch cannot be closed completely in less than 1 millisecond.

The object of the invention, therefore, is to provide a short-circuiting apparatus and an apparatus of the type mentioned initially which allow cost-effective high-speed short-circuiting, while at the same time providing a high current carrying capability.

The invention achieves this object by the switching chamber being a vacuum switching chamber in which there is a vacuum.

The inventive step lies in the combination of two components, which are combined to form an extremely high-speed tripping high-voltage switch with a high current carrying capability. According to the invention, the contact assembly to be closed by the pyrotechnic drive is arranged in a vacuum environment, specifically a vacuum switching chamber, for example a vacuum interrupter tube. The distance between the contacts of the contact assembly in the vacuum can be significantly shorter than in an air atmosphere, when the same voltage is dropped across the contacts in their interrupter position. As the distance between the switching contacts of the contact assembly becomes shorter, their closing time is shortened, however. The shorter distance between the switching contacts therefore allows these to have a larger mass without departing from the required switching time range, for example switching times of less than 1 millisecond. Switching contacts which have a higher mass have a higher current carrying capability, however, as a result of which parallel switching of a second switching stage has become superfluous within the scope of the invention. The short-circuiting apparatus according to the invention is therefore compact, has a short closing time, and has a sufficiently high current carrying capability.

Furthermore, only a limited amount of energy is also required to initiate the pyrotechnic drive, and large forces can be introduced into the contact assembly. The apparatus according to the invention is therefore functionally reliable even over a long life, thus allowing reliable switching even over a period of years.

The pyrotechnic drive advantageously has a pyrotechnic force element which has an explosive charge and an initiating means which can be moved by the explosive charge. By way of example, the housing provides protection for the parallel-switched electrical module. The walls of the housing are expediently sufficiently thick to prevent bursting of the housing or of other parts of the pyrotechnic drive when an explosion occurs, or in other words when initiation occurs.

According to one preferred refinement of the invention, the contact assembly has at least one moving contact which is mechanically connected to the initiating means via connecting means. The initiation of the pyrotechnic drive moves the initiating means, with the movement of the initiating means being introduced via the connecting means into the moving contact of the contact assembly. In the process, each moving contact comes into contact, for example, with a stationary contact which is fitted fixed in the vacuum switching chamber, thus allowing a current to flow via the contact assembly.

According to one further refinement which is expedient in this context, the moving contact and the initiating means are guided such that they can move in a longitudinal direction, wherein the moving contact and the initiating means are arranged one behind the other in said longitudinal direction. The initiation of the pyrotechnic drive results in the initiating means carrying out a linear movement. For example, a pin is thus moved in said longitudinal direction. This linear movement is introduced directly via the connecting means into the moving contact, which can likewise move longitudinally, of the contact assembly, wherein the movement directions of the moving contact and initiating means are aligned with one another, or in other words are colinear with respect to one another. Because of this aligned arrangement, a simple and cost-effective longitudinal connection, for example a rigid push rod or the like, is sufficient for use as the connecting means, in order to introduce the pyrotechnically produced movement energy into the moving contact of the contact assembly. The connecting means are therefore preferably in the form of a rigid longitudinal connection.

An electrically non-conductive holding frame is expediently provided in order to hold the vacuum switching chamber and the pyrotechnic drive. The holding frame therefore ensures that there is a constant distance, even in the event of an explosion, between the vacuum switching chamber, or in other words the vacuum interrupter and the pyrotechnic drive. The movement energy which is produced by initiating the pyrotechnic drive can therefore not blow out, but lead only to closing of the contact assembly, because of the fixed retention.

A fuze which can be initiated electrically is expediently provided in order to initiate a switching movement of the pyrotechnic drive. Electrical fuzes are known per se, and there is therefore no need to describe them in detail at this point.

Further expedient refinements and advantages of the invention are the subject matter of the following description of exemplary embodiments, with reference to the figures in the drawing, in which the same reference symbols refer to components having the same effect, and in which:

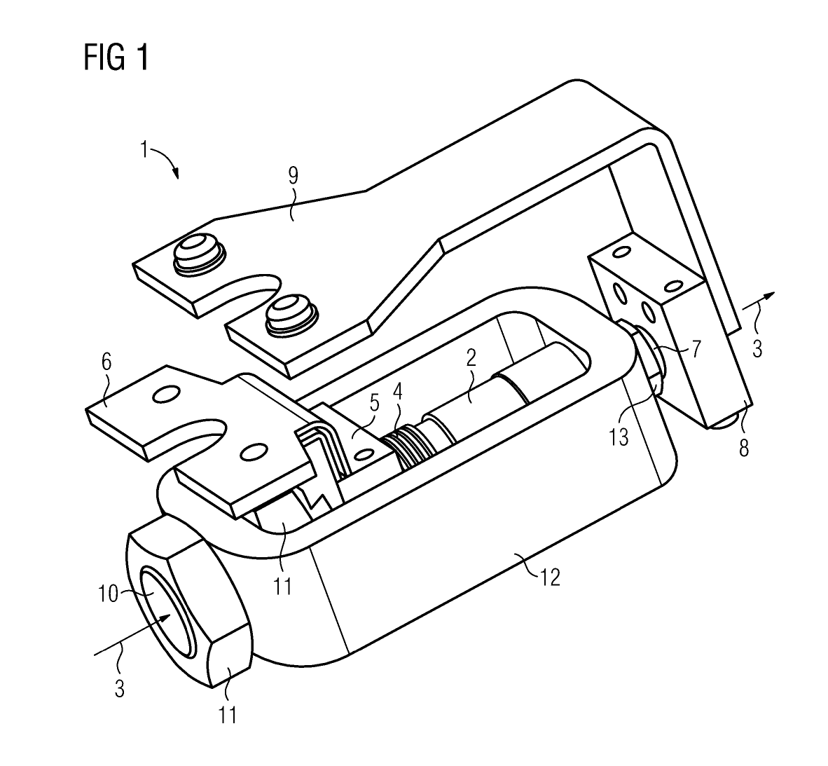

FIG. 1 shows one exemplary embodiment of the short-circuiting apparatus according to the invention, in the form of a perspective view,

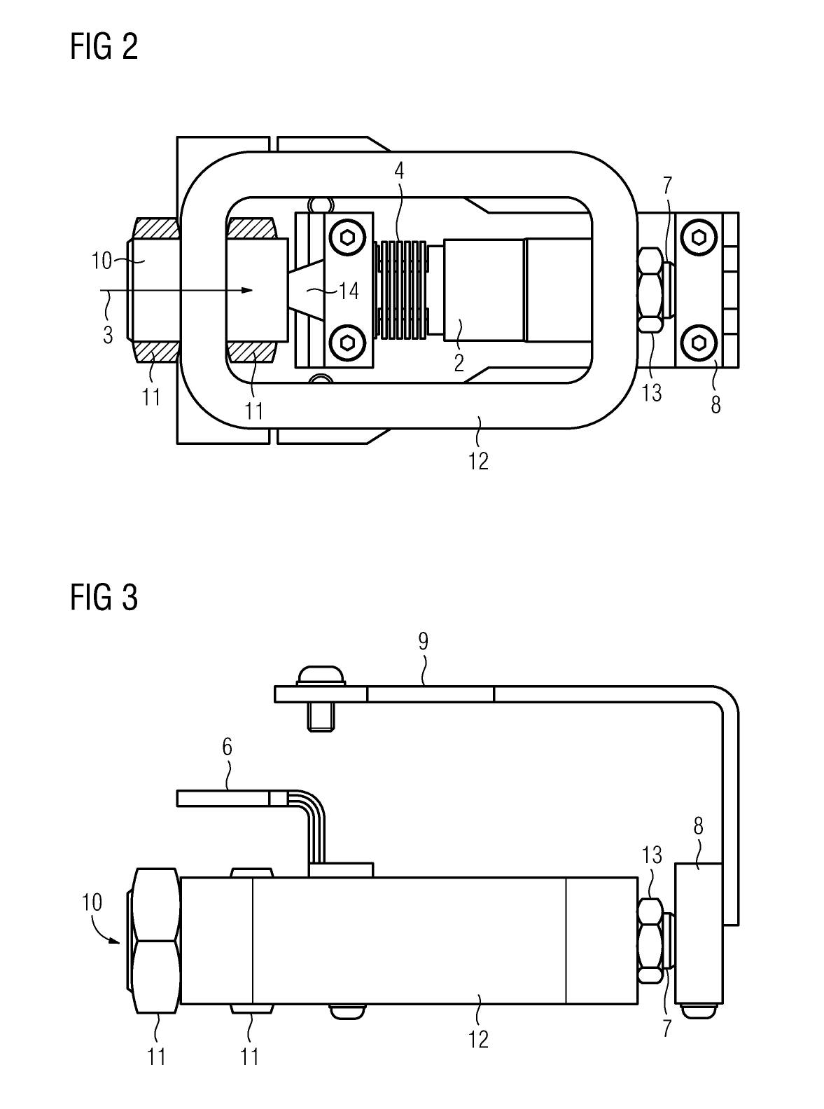

FIG. 2 shows the short-circuiting apparatus shown in FIG. 1, from underneath, and

FIG. 3 shows the short-circuiting apparatus from FIG. 1, in the form of a side view.

FIG. 1 shows one exemplary embodiment of the short-circuiting apparatus 1 according to the invention, in the form of a perspective illustration. The illustrated short-circuiting apparatus 1 has a vacuum interrupter tube 2 which, in its interior, forms a vacuum switching chamber, which is not illustrated in the figures but in which there is a vacuum. A stationary contact, which is not illustrated in the figures but is connected firmly to the vacuum interrupter tube 2, and a moving contact are located opposite, in a longitudinal direction 3, in the vacuum chamber of the vacuum interrupter tube 2. The moving contact is guided such that it can move in the longitudinal direction 3, as a result of which the moving contact is forced against the stationary contact by initiation of a drive movement, in this case a linear movement, thus allowing a current to flow via the vacuum interrupter tube 2.

A metal bellows 4 is provided in order to hold the moving contact such that it can move, while at the same time maintaining the vacuum in the interior of the vacuum switching chamber. The metal bellows 4 is attached in a vacuum-tight manner to a moving contact bolt, which is fitted with the moving contact at its free end. That end of the moving contact bolt which is remote from the moving contact extends outside the vacuum interrupter tube, where it is electrically connected via a sliding contact to a moving contact clamping piece 5, to which a moving contact connecting terminal 6 is attached.

The stationary contact of the vacuum interrupter tube 2 is attached to an end of a stationary contact bolt 7 which projects into the vacuum switching chamber, passes through the boundary wall of the vacuum interrupter tube 2, and is electrically connected at its end remote from the stationary contact to a stationary contact clamping piece 8. The stationary contact clamping piece 8 is used for fitting a stationary contact connecting terminal 9.

A pyrotechnic drive 10 is provided opposite the moving contact bolt, which cannot be seen in FIG. 1, in the longitudinal direction 3, and is firmly connected to a holding frame 12 via two attachment screws 11. The holding frame 12 is electrically non-conductive and is composed of an insulating material, for example of a glass-fiber-reinforced plastic. The vacuum interrupter tube 2 is firmly connected to the holding frame 12 by means of an attachment nut 13 on the stationary contact bolt 7. The pyrotechnic drive 10 has an initiating means, which is not illustrated in the figures but can be moved toward the vacuum interrupter tube 2 in the longitudinal direction 3 in the event of an explosion. In this case, the initiating means is mechanically connected via connecting means 14 to the moving contact bolt and therefore to the vacuum interrupter tube 2, as a result of which the movement energy of the pyrotechnic drive 10, which is produced in the event of an explosion, is introduced in the longitudinal direction 3 into the moving contact of the contact assembly of the vacuum interrupter tube 2, which is thus moved from its interrupter position to the contact position. Therefore, after the pyrotechnic drive 10 has been initiated, a current can flow via the vacuum interrupter tube 2, and therefore from the moving contact connecting terminal 6 to the stationary contact connecting terminal 9. The pyrotechnic drive is initiated by a commercially available electrical fuze unit, which is not illustrated in the figures.

FIG. 2 shows the exemplary embodiment shown in FIG. 1, from underneath. This view shows the connecting means 14, which extend in the longitudinal direction 3 between the pyrotechnic drive 10 and the moving contact bolt, which cannot be seen in the figures, of the vacuum interrupter tube 2.

FIG. 3 shows a side view of the apparatus shown in FIG. 1, in which the moving contact bolt 7 and its attachment by means of the attachment screw 13 can be seen particularly well.

1-7. (canceled)

8. A short-circuiting apparatus for electrically bridging an electrical module, comprising:
a contact assembly disposed in a switching chamber, said contact assembly being movably disposed into an interrupter position, in which a current flow through said contact assembly is interrupted, and a contact position, in which a current can flow via said contact assembly; and
a pyrotechnic drive for moving said contact assembly from the interrupter position to the contact position;
wherein said switching chamber is a vacuum switching chamber containing a vacuum therein.

9. The short-circuiting apparatus according to claim 8, wherein said pyrotechnic drive comprises a pyrotechnic force element with an explosive charge and an initiating device movable by said explosive charge.

10. The short-circuiting apparatus according to claim 9, wherein said contact assembly has at least one moving contact mechanically connected to said initiating device via a connection.

11. The short-circuiting apparatus according to claim 10, wherein said moving contact and said initiating device are guided for movement in a longitudinal direction, with said moving contact and said initiating device being disposed one behind the other in the longitudinal direction.

12. The short-circuiting apparatus according to claim 8, which comprises an electrically non-conductive holding frame for holding said vacuum switching chamber and said pyrotechnic drive.

13. The short-circuiting apparatus according to claim 8, which comprises a fuze unit, configured for electrical triggering, in order to initiate a switching movement of said pyrotechnic drive.

14. In a power transmission and distribution system, an apparatus for converting an electrical current, comprising:
a plurality of power semiconductor modules connected to one another via electrical connectors to form a series circuit;
each of said power semiconductor modules having a short-circuiting device according to claim 8 associated therewith for bridging the respective said power semiconductor module.
